(19) United States
(12) Patent Application Publication
(10) Pub. No.: US 2024/0219872 A1
(43) Pub. Date: Jul. 4, 2024

(54) MANUFACTURING-APPARATUS DESIGN VERIFICATION SYSTEM

(71) Applicant: Mitsubishi Electric Corporation, Tokyo (JP)

(72) Inventors: Kazuhiro ABE, Tokyo (JP); Satoshi IWATSU, Tokyo (JP); Kohei FUJITA, Tokyo (JP); Hiroaki INOUE, Tokyo (JP)

(73) Assignee: Mitsubishi Electric Corporation, Tokyo (JP)

(21) Appl. No.: 18/289,026

(22) PCT Filed: May 10, 2021
(86) PCT No.: PCT/JP2021/017637

§ 371 Date: Oct. 31, 2023

(51) Int. Cl. G05B 13/04

(52) U.S. Cl. CPC G05B 13/041

(57) ABSTRACT

A manufacturing-apparatus design verification system includes a control-program slicing device that extracts a common group that collects circuit blocks that share a contact and a coil in a ladder program designed by a control-program design device. A identification device for identifying to-be-affected-by-change portions in final design products determines a correspondence among final design products of a machine design device, an electric design device, and the control-program design device in accordance with the extracted common group and, when a change is made to the final design product of any of the machine design device, the machine design device, and the control-program design device, identifies a portion to be affected by the change in the final design products of the other design devices different from the design device that has undergone the change.

### TECHNICAL FIELD

The present disclosure relates to a manufacturing-apparatus design verification system for verifying cooperation among a plurality of design devices for designing a manufacturing apparatus.

### BACKGROUND ART

In the field of factory automation (FA), a ladder program is often used as a description language in a control-program design device that is one of design devices for designing a manufacturing apparatus. It is often the case that the ladder program is not structured in which contacts and coils linked to sensors and actuators are scattered in the program. Patent Document 1 below discloses extracting contacts and coils to be used in circuit blocks in the ladder program and generating a common group that collects a plurality of circuit blocks that share contacts and coils to be used.

### PRIOR ART DOCUMENT

### Patent Document

Patent Document 1: International Publication No. 2016/17004

### SUMMARY

### Problem to be Solved by the Invention

In the case where a change is made to the final design product of one of a plurality of cooperating design devices, it is difficult for the other design devices to identify a portion to be affected by the change (hereinafter, also referred to as a “to-be-affected-by-change portion”). For example, in the case where a change is made to the ladder program in a control-program design device, this change will affect the final design products of a machine design device and an electric design device, but it is difficult to specifically identify a portion to be affected by the change.

The present disclosure has been made in order to solve the problem as described above, and it is an object of the present disclosure to, when a change is made to the final design product of any of a machine design device, an electric design device, and a control-program design device, allow identification of portions to be affected by the change in the final design products of the other design devices.

### Means to Solve the Problem

A manufacturing-apparatus design verification system according to the present disclosure is a manufacturing-apparatus design verification system for verifying a design of a manufacturing apparatus for manufacturing a product. The manufacturing-apparatus design verification system includes a machine design device that designs a physical shape of the manufacturing apparatus and operations of a sensor and an actuator, the sensor detecting a moving part and work of the manufacturing apparatus, the actuator driving the moving part, an electric design device that associates the sensor and the actuator arranged in the manufacturing apparatus with a device in a control program of the manufacturing apparatus, a control-program design device that designs the control program of the manufacturing apparatus, a control-program slicing device that extracts a common group in which program blocks in the control program share a device, and an identification device for identifying a portion to be affected by a change in a final design product, the identification device determining a correspondence among final design products of the machine design device, the electric design device, and the control-program design device in accordance with the common group of the control program extracted by the control-program slicing device and, when a change is made to the final design product of any of the machine design device, the machine design device, and the control-program design device, identifying a portion to be affected by the change in the final design product of another design device different from the design device that has undergone the change.

### Effects of the Invention

The manufacturing-apparatus design verification system according to the present disclosure achieves the effect of, when a change is made to the final design product of any of the machine design device, the electric design device, and the control-program design device, allowing identification of portions to be affected by the change in the final design products of the other design devices different from the design device that has undergone the change.

The objects, features, aspects and advantages of the present disclosure will become more apparent from the following detailed description of the present disclosure when taken in conjunction with the accompanying drawings.

### BRIEF DESCRIPTION OF DRAWINGS

FIG. 1 is a block diagram showing a configuration of a manufacturing-apparatus design verification system according to Embodiment 1.

FIG. 2 is a diagram showing an example of a ladder program designed by a control programming control device.

FIG. 3 is a flowchart of detecting a to-be-affected-by-change portion in the final design product of the manufacturing-apparatus design verification system according to Embodiment 1.

FIG. 4 is a block diagram showing a configuration of a manufacturing-apparatus design verification system according to Embodiment 2.

FIG. 5 is a flowchart showing operations of the manufacturing-apparatus design verification system according to Embodiment 2.

FIG. 6 is a block diagram showing a configuration of a manufacturing-apparatus design verification system according to Embodiment 3.

FIG. 7 is a flowchart showing operations performed by the manufacturing-apparatus design verification system according to Embodiment 3 when storing verification data.

FIG. 8 is a flowchart showing operations of the manufacturing-apparatus design verification system according to Embodiment 3.

### DESCRIPTION OF EMBODIMENTS

### Embodiment 1

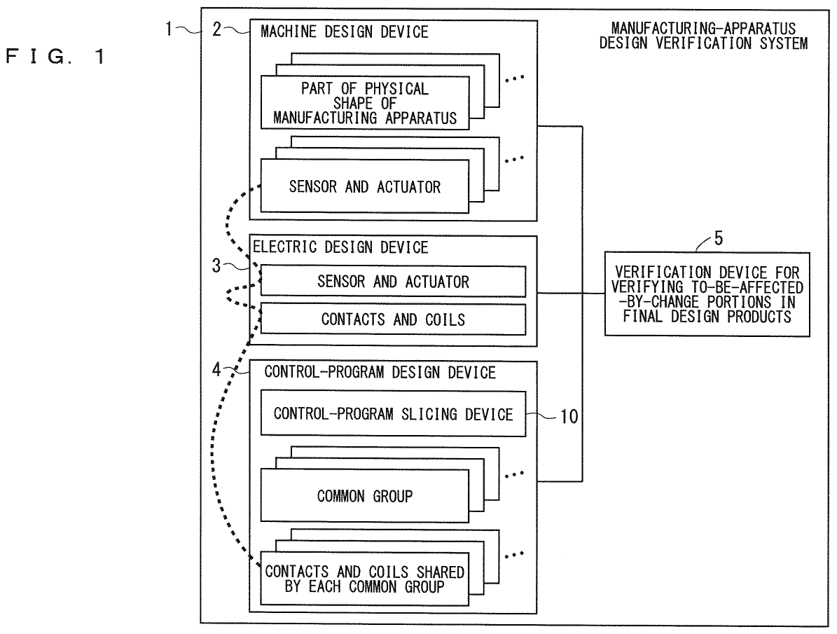

FIG. 1 is a block diagram showing a configuration of a manufacturing-apparatus design verification system 1 according to Embodiment 1. As shown in FIG. 1, the manufacturing-apparatus design verification system 1 according to Embodiment 1 includes a machine design device 2, an electric design device 3, a control-program design device 4, and an identification device 5 for identifying to-be-affected-by-change portions in final design products. The machine design device 2, the electric design device 3, and the control-program design device 4 are a plurality of cooperating design devices for designing a manufacturing apparatus.

Note that the manufacturing-apparatus design verification system 1 is implemented by a processor executing application programs for achieving functions of various constituent elements. That is, the manufacturing-apparatus design verification system 1 may be implemented as, for example, a hardware configuration that includes memory for storing the aforementioned programs and the processor for executing these programs.

The machine design device 2 is a design device for making a machine design of the manufacturing apparatus and specifically designing physical shapes (mechanical shapes) of various units of the manufacturing apparatus and operations of sensors and actuators, the sensors detecting a moving part and work of the manufacturing apparatus, the actuators driving the moving part of the manufacturing apparatus. The machine design device 2 generates, as its final design products, design data on the physical shapes of various units of the manufacturing apparatus and design data on the operations of sensors and actuators that respectively detect and drive various units of the manufacturing apparatus.

The electric design device 3 is a design device for making an electric design of the manufacturing apparatus and specifically associating the sensors and actuators of the manufacturing apparatus with contacts and coils in a control program of the manufacturing apparatus described in a ladder language. The electric design device 3 generates, as its final design product, data indicating the relationship of association between the sensors and actuators of the manufacturing apparatus and the contacts and coils in the control program of the manufacturing apparatus.

The control-program design device 4 is a design device for designing a control program of the manufacturing apparatus and more specifically designing a control program that defines operations of controllers in a control unit into the ladder language. The control-program design device 4 generates, as its final design product, a control program described in the ladder language (hereinafter, also referred to as the “ladder program”).

According to Embodiment 1, the control-program design device 4 includes a control-program slicing device 10 that extracts a common group that collects program blocks that use a common device, from among program blocks that configure the designed control program. In the case where the control program is the ladder program as in the present embodiment, the control-program slicing device 10 extracts a common group that collects circuit blocks that share contacts and coils, from among circuit blocks in the ladder program. More specifically, the control-program slicing device 10 extracts contacts and coils to be used in each circuit block from the ladder program and generates data on common groups of collecting a plurality of circuit blocks that share the same contacts and coils, and data on contacts and coils shared by each common group. The control-program slicing device 10 may have an operation logic similar to that used in the technique disclosed in Patent Document 1 above.

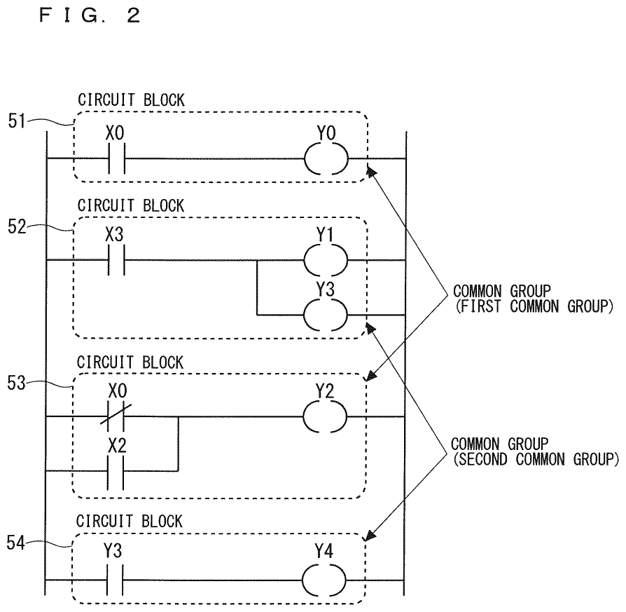

Using a specific example of the ladder program, operations of the control-program slicing device 10 will now be described in more detail. FIG. 2 shows one example of the ladder program. The ladder program includes four circuit blocks 51 to 54. In the case where the ladder program is as shown in the example in FIG. 2, the control-program slicing device 10 collects circuit blocks that include common devices (contacts and coils) as a common group from circuit blocks 51 to 54 in the ladder program. The control-program slicing device 10 also extracts a group of all contacts and coils that are referenced by circuit blocks included in each common group as contacts and coils shared by the common group.

In the example illustrated in FIG. 2, circuit blocks 51 and 53 that include a common device X0 are collected as a first common group, and circuit blocks 52 and 54 that include a common device Y3 are collected as a second common group. Contacts and coils shared by the first common group are devices X0, Y0, X2, and Y2, which form a group of all contacts and coils to be referenced by the circuit blocks 51 and 53. Contacts and coils shared by the second common group are devices X3, Y1, Y3, and Y4, which form a group of all contacts and coils to be referenced by the circuit blocks 52 and 52. Contacts and coils that belong to different common groups are mutually exclusive, so that the circuit blocks belonging to the first common group and the circuit blocks belonging to the second common group operate independently.

Referring back to FIG. 1, in the case where a change is made to the final design product of any of the machine design device 2, the electric design device 3, and the control-program design device 4, the identification device 5 for identifying to-be-affected-by-change portions in final design products identifies to-be-affected-by-change portions in the final design products of the other design devices different from the design device that has undergone the change, in accordance with the correspondence among the final design products of the machine design device 2, the electric design device 3, and the control-program design device 4. The identification device 5 for identifying to-be-affected-by-change portions in final design products determines the correspondence among the final design produces in accordance with the data on common groups in circuit blocks and the data on contacts and coils shared by each common group, which are extracted from the ladder program by the control-program slicing device 10.

As described above, the final design product of the machine design device 2 includes the design data on the physical shapes of various units of the manufacturing apparatus and the design data on the operations of sensors and actuators that respectively detect and drive various units of the manufacturing apparatus. The final design product of the electric design device 3 includes the data indicating the relationship of association between the sensors and actuators of the manufacturing apparatus and the contacts and coils in the control program of the manufacturing apparatus. The final design product of the control-program design device 4 includes the control program (ladder program) of the manufacturing apparatus.

For example, a correspondence between the final design products of the machine design device 2 and the electric design device 3 can be determined from the correspondence between sensors and actuators that are allocated to various units of the manufacturing apparatus by the machine design device 2 and sensors and actuators that are to be associated by the electric design device 3. A correspondence between the final design products of the electric design device 3 and the control-program design device 4 can be determined from the correspondence between contacts and coils in the control program that are to be associated by the electric design device 3 and contacts and coils that are shared by each common group extracted by the control-program slicing device 10. A correspondence between the final design products of the machine design device 2 and the control-program design device 4 can be determined from the correspondence between the final design products of the machine design device 2 and the electric design device 3 and the correspondence between the final design products of the electric design device 3 and the control-program design device 4.

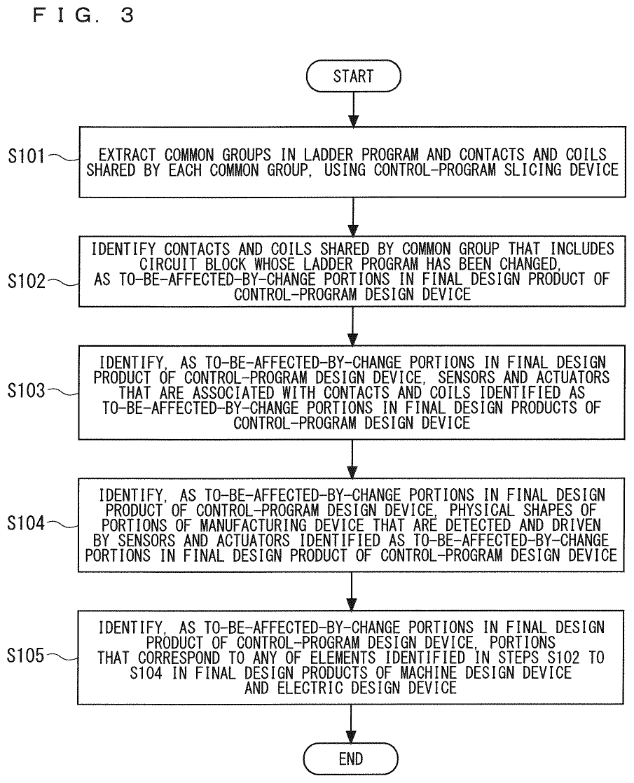

FIG. 3 is a flowchart showing one example of operations performed by the identification device 5 for identifying to-be-affected-by-change portions in final design products. The flowchart in FIG. 3 shows the operations performed when a change has been made to the final design product of the control-program design device 4, i.e., the ladder program, and the identification device 5 for identifying to-be-affected-by-change portions in final design products identifies portions to be affected by the change in the machine design device 2 and the electric design device 3.

In the case where a change has been made to the ladder program, i.e., the final design product of the control-program design device 4, the identification device 5 for identifying to-be-affected-by-change portions in final design products executes steps S101 to S105 shown in FIG. 3.

In step S101, by using the control-program slicing device 10, the identification device 5 for identifying to-be-affected-by-change portions in final design products extracts, from the changed ladder program, contacts and coils to be used in each circuit block in the ladder program and extracts common groups, each collecting a plurality of circuit blocks that use common contacts and coils, and contacts and coils shared by each common group.

In step S102, the identification device 5 for identifying to-be-affected-by-change portions in final design products identifies a common group that includes a circuit block whose ladder program has been changed, and identifies contacts and coils shared by the identified common group. Then, the identified contacts and coils are specified as to-be-affected-by-change portions in the final design product of the control-program design device 4.

In step S103, the identification device 5 for identifying to-be-affected-by-change portions in final design products identifies sensors and actuators with which the contacts and coils specified as the to-be-affected-by-change portions in step S102 are associated by the electric design device 3, and specifies the identified sensors and actuators as to-be-affected-by-change portions in the final design product of the control-program design device 4.

In step S104, the identification device 5 for identifying to-be-affected-by-change portions in final design products identifies units of the manufacturing apparatus to which the sensors and actuators specified as the to-be-affected-by-change portions in step S103 are allocated for detection and driving by the machine design device 2, and specifies the physical shapes of the identified units as to-be-affected-by-change portions in the final design product of the control-program design device 4.

In step S105, the identification device 5 for identifying to-be-affected-by-change portions in final design products specifies, as to-be-affected-by-change portions in the final design product of the control-program design device 4, portions of the final design products of the machine design device 2 and the electric design device 3 that correspond to any of the elements specified as the to-be-affected-by-change portions in the final design product of the control-program design device 4 in steps S102 to S104 (the contacts and coils in the ladder program, the sensors and actuators of the manufacturing apparatus, and the physical shapes of the units of the manufacturing apparatus).

Through the processing described above, the identification device 5 for identifying to-be-affected-by-change portions in final design products is capable of identifying the to-be-affected-by-change portions in the final design products of the machine design device 2 and the electric design device 3 when a change has been made to the final design product of the control-program design device 4.

Although a detailed description is omitted, a similar technique used in the processing shown in FIG. 3 is also applicable to other cases, such as the case of identifying to-be-affected-by-change portions in the final design products of the electric design device 3 and the control-program design device 4 when a change has been made to the final design product of the machine design device 2, or the case of identifying to-be-affected-by-change portions in the final design products of the machine design device 2 and the control-program design device 4 when a change has been made to the final design product of the electric design device 3.

Note that all or part of the manufacturing-apparatus design verification system 1 according to Embodiment 1 may be operated in the cloud. In this case, even if a machine designer, an electric designer, and a control program designer of the manufacturing apparatus work at distant places, it is possible to, when a change has been made to the final design product of any of the machine design device 2, the electric design device 3, and the control-program design device 4, reduce the time and effort of adjustment among persons in charge of the other design devices.

### Embodiment 2

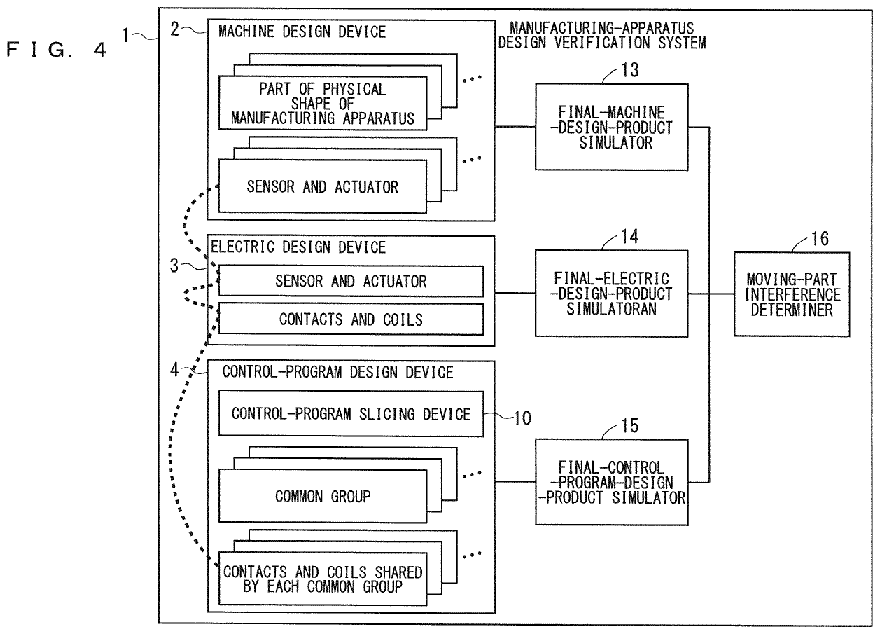

FIG. 4 is a block diagram showing a configuration of a manufacturing-apparatus design verification system 1 according to Embodiment 2. As shown in FIG. 4, the manufacturing-apparatus design verification system 1 according to Embodiment 2 includes a machine design device 2, an electric design device 3, a control-program design device 4, a final-machine-design-product simulator 13, a final-electric-design-product simulator 14, a final-control-program-design-product simulator 15, and a moving-part interference determiner 16. The machine design device 2, the electric design device 3, and the control-program design device 4 are a plurality of cooperating design devices for designing the manufacturing apparatus.

The machine design device 2, the electric design device 3, and the control-program design device 4 (including the control-program slicing device 10) are the same as those described in Embodiment 1.

The final-machine-design-product simulator 13 is a simulator that virtually operates the final design product of the machine design device 2 in a calculating machine. The final-electric-design-product simulator 14 is a simulator that virtually operates the final design product of the electric design device 3 in a calculating machine. The final-control-program-design-product simulator 15 is a simulator that virtually operates the final design product of the control-program design device 4 in a calculating machine. The moving-part interference determiner 16 determines whether interference occurs between the moving part of the manufacturing apparatus and elements other than the moving part thereof (hereinafter, referred to as “residual parts”) during simulation of operating the final design product of the machine design device 2 in the final-machine-design-product simulator 13 and, if interference occurs, identifies portions that become the cause of the interference in the control program (ladder program) that is the final design product of the control-program design device 4.

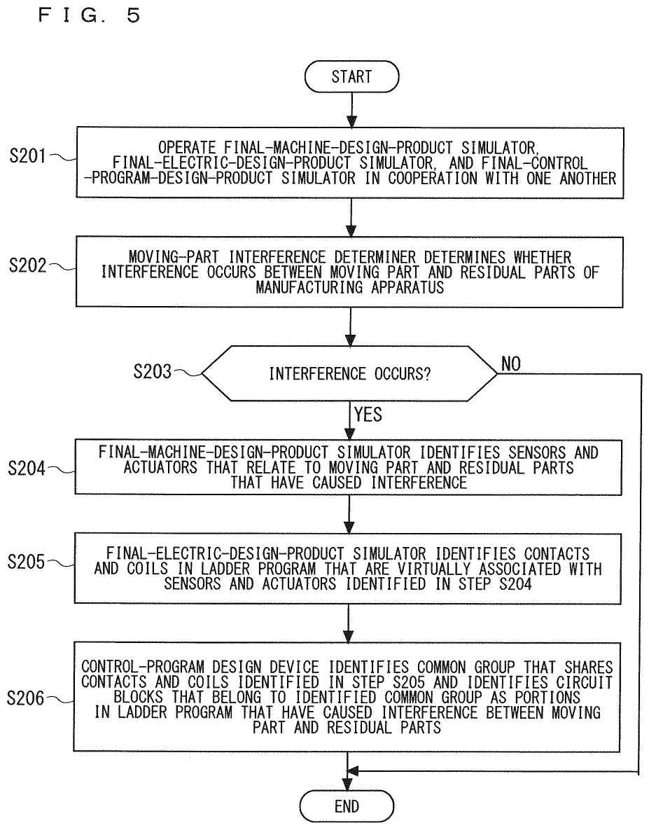

FIG. 5 is a flowchart showing operations of the manufacturing-apparatus design verification system 1 according to Embodiment 2. The manufacturing-apparatus design verification system 1 executes steps S201 to S206 shown in FIG. 5.

In step S201, the final design products of the machine design device 2, the electric design device 3, and the control-program design device 4 are executed by the final-machine-design-product simulator 13, the final-electric-design-product simulator 14, and the final-control-program-design-product simulator 15, respectively, in corporation (synchronization) with one another. That is, the ladder program, which is the final design product of the control-program design device 4, is virtually operated by the final-control-program-design-product simulator 15, the association between the contacts and coils and the sensors and actuators, which is the final design product of the electric design device 3, is virtually made by the final-electric-design-product simulator 14, and the physical shapes of various units of the manufacturing apparatus and the operations of sensors and actuators that respectively detect and drive various units, which are the final design product of the machine design device 2, are virtually implemented by the final-machine-design-product simulator 13.

In step S202, the moving-part interference determiner 16 determines whether interference occurs between the moving part and residual parts of the manufacturing apparatus, which are the final design product of the machine design device 2, during simulation performed by the final-machine-design-product simulator 13. The function of making this determination is achieved by many of general 3D CAD simulators. Note that the association between the physical shapes of various units of the manufacturing apparatus and the sensors and actuators of the manufacturing apparatus are managed by the final-machine-design-product simulator 13.

In step S203, the result of the determination in step S202 is classified. If it is determined that interference does not occur between the moving part and residual parts of the manufacturing apparatus, which are the final design product of the machine design device 2, the processing in FIG. 5 ends. If it is determined that interference occurs between the moving part and residual parts of the manufacturing apparatus, which are the final design product of the machine design device 2, the processing proceeds to step S204.

In step S204, the final-machine-design-product simulator 13 identifies sensors and actuators that relate to the moving part and residual parts that have caused interference during simulation.

In step S205, the final-electric-design-product simulator 14 identifies contacts and coils in the ladder program that are virtually associated with the sensors and actuators identified in step S204 (i.e., the sensors and the actuators that relate to the moving part and the residual parts that have caused interference during simulation).

In step S206, the control-program design device 4 identifies a common group in the ladder program that shares the contacts and the coils identified in step S205 (i.e., the contacts and coils virtually associated with the sensors and actuators that relate to the moving part and the residual parts that have caused interference during simulation), and specifies circuit blocks that belong to the identified common group as portions in the ladder program that have become the cause of the interference between the moving part and the residual parts during simulation.

In this way, the manufacturing-apparatus design verification system 1 according to Embodiment 2 is capable of determining, in the design phase, whether interference occurs between the moving part and residual parts of the manufacturing apparatus by simulating the operations of the manufacturing apparatus implemented by the final design products of the machine design device 2, the electric design device 3, and the control-program design device 4. Moreover, if it is determined that interference occurs between the moving part of and residual parts of the manufacturing apparatus, it is possible to identify portions that become the cause of the interference in the control program (ladder program), which is the final design product of the control-program design device 4, by a similar method to that used in Embodiment 1.

Note that all or part of the manufacturing-apparatus design verification system 1 may be operated in the cloud. In this case, even if a machine designer, an electric designer, and a control program designer of the manufacturing apparatus work at distant places, it is possible to, when a change has been made to the final design product of any design device, determine in the design phase whether interference occurs between the moving part and residual parts of the manufacturing apparatus by operating the final-machine-design-product simulator 13, the electric design simulator, and the control program design simulator in corporation with one another.

In the manufacturing-apparatus design verification system 1 according to Embodiment 2, the moving-part interference determiner 16 may have a function of detecting interlock in which the moving part serving as the final design product of the machine design device 2 and other moving parts occupy the same space at the same time. In this case, in the case where a change has been made to the final design product of any design device, it is possible to verify, in the design phase, whether the inconsistency of affecting the interlock by the manufacturing apparatus occurs among the final design products of the machine design device 2, the electric design device 3, and the control-program design device 4.

In the manufacturing-apparatus design verification system 1 according to Embodiment 2, the moving-part interference determiner 16 may have a function of detecting whether the moving part serving as the final design product of the machine design device 2 operates at a predetermined tact time. In this case, it is possible to verify, in the design phase, whether the portion of the manufacturing apparatus that includes the moving part operates at a predetermined tact time and whether inconsistency occurs among the final design products of the machine design device 2, the electric design device 3, and the control-program design device 4.

### Embodiment 3

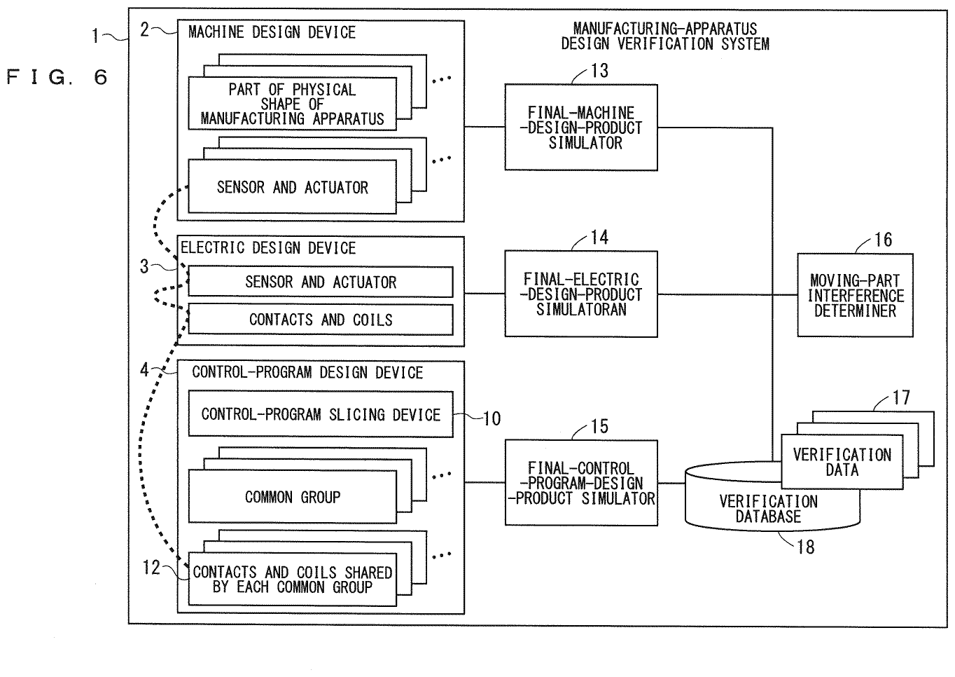

FIG. 6 is a block diagram showing a configuration of a manufacturing-apparatus design verification system 1 according to Embodiment 3. The configuration of the manufacturing-apparatus design verification system 1 in FIG. 6 is equivalent to adding a verification database 18 for storing verification data 17 to the configuration shown in FIG. 4.

The verification data 17 is generated when interference does not occur between the moving part and residual parts of the manufacturing apparatus, which are the final design product of the machine design device 2, during simulation performed by the final-machine-design-product simulator 13. The verification data 17 describes the final design product of the machine design device 2 that corresponds to the moving part and the residual parts that have not caused interference, i.e., the physical shapes of the moving part and the residual parts and the sensors and the actuators that relate to the moving part and the residual parts, and the final design product of the control-program design device 4 that corresponds to the moving part and the residual parts that have not caused interference, i.e., portions that relate to the moving part and the residual parts in the control program (ladder program).

The verification data 17 is stored in the verification database 18 as a positive example of the final design product of the manufacturing apparatus that satisfies the condition that interference does not occur between the moving part and the residuals parts. The moving-part interference determiner 16 learns, in accordance with the verification data 17 stored in the verification database 18, the physical shapes and operations of the moving part and the residual parts that do not cause interference.

Use of this learning contents allows the final-control-program-design-product simulator 15 to operate only part of the control program described in individual data items in the verification data 17, and allows the moving-part interference determiner 16 to determine, in the design phase, whether interference occurs between the moving part and residual parts of the manufacturing apparatus.

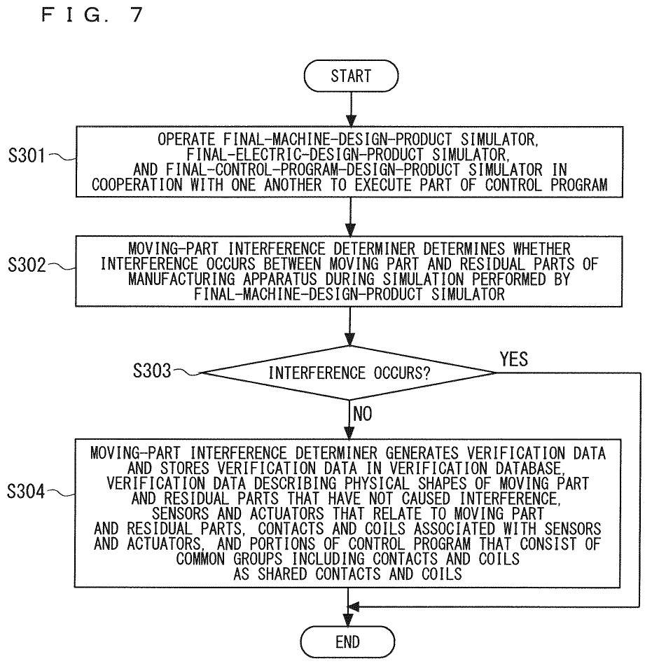

FIG. 7 is a flowchart showing operations performed by the manufacturing-apparatus design verification system 1 according to Embodiment 3 when storing the verification data 17 in the verification database 18. The manufacturing-apparatus design verification system 1 executes steps S301 to S304 shown in FIG. 7 to store the verification data 17.

In step S301, the final design products of the machine design device 2, the electric design device 3, and the control-program design device 4 are executed in cooperation (synchronization) with one another by the final-machine-design-product simulator 13, the final-electric-design-product simulator 14, and the final-control-program-design-product simulator 15, respectively. At this time, the final-control-program-design-product simulator 15 does not need to operate the entire ladder program, which is the final design product of the control-program design device 4, and operates part of the program that consists of a common group that includes, as shared contacts and coils, contacts and coils that are associated with the sensors and the actuators in the final design product of the electric design device 3.

In step S302, the moving-part interference determiner 16 determines whether interference occurs between the moving part and residual parts of the manufacturing apparatus, which are the final design product of the machine design device 2, during simulation performed by the final-machine-design-product simulator 13.

In step S303, the result of the determination in step S302 is classified. If it is determined that interference does not occur between the moving part and residual parts of the manufacturing apparatus, which are the final design product of the machine design device 2, the processing in FIG. 7 ends. If it is determined that interference occurs between the moving part and residual parts of the manufacturing apparatus, which are the final design product of the machine design device 2, the processing proceeds to step S304.

In step S304, the moving-part interference determiner 16 generates the verification data 17 and stores the generated verification data 17 as a positive example in the verification database 18. The verification data 17 describes the final design product of the machine design device 2 that corresponds to the moving part and the residual parts that have not caused interference, i.e., the physical shapes of the moving part and the residual parts and sensors and actuators that relate to the moving part and the residual parts; contacts and coils that are associated with the sensors and the actuators by the electric design device 3; and portions consisting of the common group that includes the contacts and coils in the control program, which is the final design product of the design device 4, as shared contacts and coils (i.e., portions operated by the final-control-program-design-product simulator 15 in step S301).

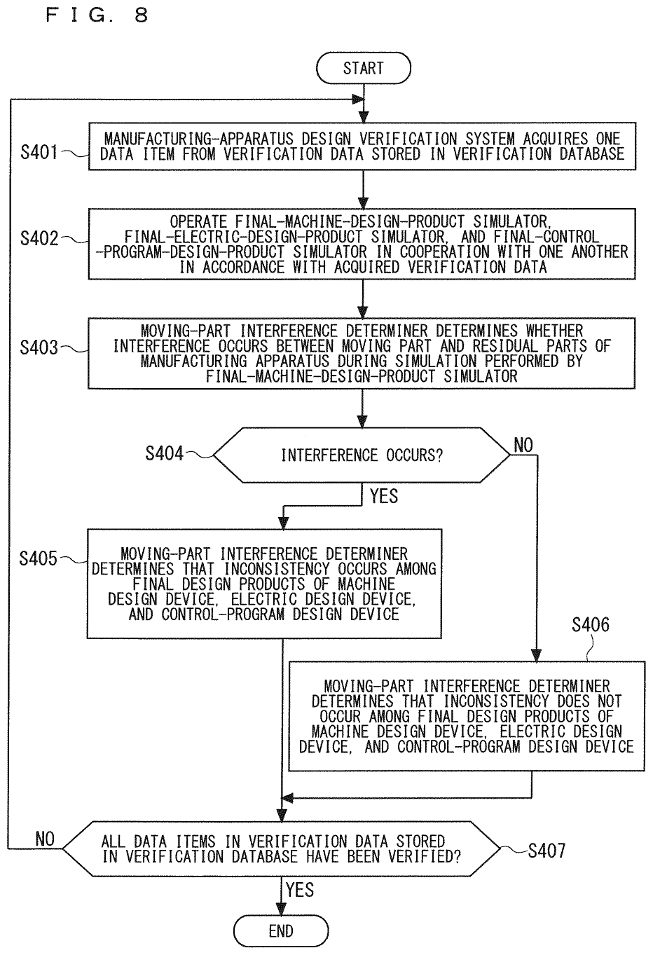

FIG. 8 is a flowchart showing operations performed by the manufacturing-apparatus design verification system 1 according to Embodiment 3 when a change has been made to the final design product of any design device, in order to verify whether inconsistency due to the change occurs among the final design products of the machine design device 2, the electric design device 3, and the control-program design device 4. For the verification, the manufacturing-apparatus design verification system 1 executes steps S401 to S407 shown in FIG. 7.

In step S401, the manufacturing-apparatus design verification system 1 acquires one data item that has not been verified yet, from the verification data 17 stored in the verification database 18.

In step S402, the final design product of the machine design device 2 described in the acquired verification data 17, the final design product of the electric design device 3 described in the acquired verification data 17, and the final design product of the control-program design device 4 described in the acquired verification data 17 are executed in cooperation (synchronization) with one another by the final-machine-design-product simulator 13, the final-electric-design-product simulator 14, and the final-control-program-design-product simulator 15, respectively. That is, the final-control-program-design-product simulator 15 operates only part of the ladder program described in the verification data 17 acquired in step S401, instead of operating the entire ladder program that is the final design product of the control-program design device 4.

In step S403, the moving-part interference determiner 16 determines whether interference occurs between the moving part and residual parts of the manufacturing apparatus, which are the final design products of the machine design device 2, during simulation performed by the final-machine-design-product simulator 13.

In step S404, the result of the determination in step S403 is classified. If it is determined interference occurs between the moving part and residual parts of the manufacturing apparatus, which are the final design product of the machine design device 2, the processing proceeds to step S405. In step S405, the moving-part interference determiner 16 determines whether inconsistency occurs among the final design products of the machine design device 2, the electric design device 3, and the control-program design device 4.

On the other hand, if it is determined that interference does not occur between the moving part and residual parts of the manufacturing apparatus, which are the final design product of the machine design device 2, the processing proceeds to step S406. In step S406, the moving-part interference determiner 16 determines that inconsistency does not occur among the final design products of the machine design device 2, the electric design device 3, and the control-program design device 4.

In step S407 after step S405 or S406, the moving-part interference determiner 16 confirms whether all data items in the verification data 17 stored in the verification database 18 have been verified. If all of the data items in the verification data 17 have already been verified, the processing in FIG. 8 ends. If the verification data 17 includes any remaining data item that has not been verified yet, the processing returns to step S401.

In this way, in the manufacturing-apparatus design verification system 1 according to Embodiment 3, when a change has been made to part of the final design product of any of the machine design device 2, the electric design device 3, and the control-program design device 4, the final-control-program-design-product simulator 15 is capable of operating only part of the control program described in a finite number of verification data 17 stored in the verification database 18, and the moving-part interference determiner 16 is capable of determining, in the design phase, whether interference occurs between the moving part and residual parts of the manufacturing apparatus. This allows the manufacturing-apparatus design verification system 1 to verify, in the design phase, whether inconsistency occurs among the final design products of the machine design device 2, the electric design device 3, and the control-program design device 4.

Note that all or part of the manufacturing-apparatus design verification system 1 according to Embodiment 3 may be operated in the cloud. In this case, even if a machine designer, an electric designer, and a control program designer for the manufacturing apparatus work at distant places, it is possible to, when a change is made to the final design product of any design device, operate the final-machine-design-product simulator 13, the electric design simulator, and the control program design simulator in cooperation with one another in accordance with the verification data 17 and to verify, in the design phase, whether inconsistency occurs among the final design products of the machine design device 2, the electric design device 3, and the control-program design device 4.

In the manufacturing-apparatus design verification system 1 according to Embodiment 3, the moving-part interference determiner 16 may have a function of detecting interlock in which the moving part serving as the final design product of the machine design device 2 and other moving parts occupy the same space at the same time. In this case, when a change is made to the final design product of any design device, it is possible to verify, in the design phase, whether the inconsistency of affecting the interlock by the manufacturing apparatus occurs among the final design products of the machine design device 2, the electric design device 3, and the control-program design device 4.

In the manufacturing-apparatus design verification system 1 according to Embodiment 3, the moving-part interference determiner 16 may also have a function of detecting whether the moving part serving as the final design product of the machine design device 2 operates at a predetermined tact time. In this case, it is possible to verify, in the design phase, whether the portion of the manufacturing apparatus that includes the moving part operates at a predetermined tact time and whether inconsistency occurs among the final design products of the machine design device 2, the electric design device 3, and the control-program design device 4.

### Embodiment 4

Although, in Embodiments 1 to 3, the control program serving as the final design product of the control-program design device 4 is the ladder program, the control pogrom may be a program described in a text language such as the ST language or the C language (text program) by using text-language slicing technology in the control-program slicing device 10. In this case, the control-program slicing device 10 extracts text language devices used in program blocks from the text program and generates data on a common group that collects a plurality of program blocks that share a text language device and data on text language devices shared by each common group.

That is, even if the final design product of the control-program design device 4 in Embodiment 1 is a text program, it is possible to, when a change is made to the final design product of any of the machine design device 2, the electric design device 3, and the control-program design device 4, identify to-be-affected-by-change portions in the final design products of the other design devices by associating the final design product of the machine design device 2 with the final design product of the control-program design device 4. Moreover, even if the final design product of the control-program design device 4 in Embodiment 2 is a text program, it is possible to identify a portion of the control program (text program) that becomes the cause of interference between the moving part and residual parts of the manufacturing apparatus when the final design product of the machine design device 2 is virtually operated by the final-machine-design-product simulator 13. Moreover, even if the final design product of the control-program design device 4 in Embodiment 3 is a text program, it is possible to, when a change is made to the final design product of any of the machine design device 2, the electric design device 3, and the control-program design device 4, determine in the design phase whether inconsistency occurs among the final design products of the machine design device 2, the electric design device 3, and the control-program design device 4.

It should be noted that the present invention can be implemented by freely combining the above embodiments or by making a modification or omission on the embodiments as appropriate without departing from the scope of the present invention.

It is therefore to be understood that numerous modifications and variations can be devised without departing from the scope of the invention.

### EXPLANATION OF REFERENCE SIGNS

1 manufacturing-apparatus design verification system
2 machine design device
3 electric design device
4 control-program design device
5 identification device for identifying to-be affected-by-change portions in final design products
10 control-program slicing device
13 final-machine-design-product simulator
14 final-electric-design-product simulator
15 final-control-program-design-product simulator
16 moving-part interference determiner
17 verification data
18 verification database
51 to 54 circuit block

1. A manufacturing-apparatus design verification system for verifying a design of a manufacturing apparatus for manufacturing a product, the manufacturing-apparatus design verification system comprising:
a processor to execute a program; and
a memory to store the program which, when it is executed by the processor, performs processes of:
causing the processor to function as a machine design device that designs a physical shape of the manufacturing apparatus and operations of a sensor and an actuator, the sensor detecting a moving part and work of the manufacturing apparatus, the actuator driving the moving part;
causing the processor to function as an electric design device that associates the sensor and the actuator arranged in the manufacturing apparatus with a device in a control program of the manufacturing apparatus;
causing the processor to function as a control-program design device that designs the control program of the manufacturing apparatus;
causing the processor to function as a control-program slicing device that extracts a common group in which program blocks in the control program share a device; and
causing the processor to function as an identification device for identifying to-be-affected-by-change portions in final design products, the identification device determining a correspondence among final design products of the machine design device, the electric design device, and the control-program design device in accordance with the common group of the control program extracted by the control-program slicing device and, when a change is made to the final design product of any of the machine design device, the machine design device, and the control-program design device, identifying a portion to be affected by the change in the final design product of another design device different from the design device that has undergone the change.

2. A manufacturing-apparatus design verification system for verifying a design of a manufacturing apparatus for manufacturing a product, the manufacturing-apparatus design verification system comprising:
a processor to execute a program; and
a memory to store the program which, when it is executed by the processor, performs processes of:
causing the processor to function as a machine design device that designs a physical shape of the manufacturing apparatus and operations of a sensor and an actuator, the sensor detecting a moving part and work of the manufacturing apparatus, the actuator driving the moving part;
causing the processor to function as an electric design device that associates the sensor and the actuator arranged in the manufacturing apparatus with a device in a control program of the manufacturing apparatus;
causing the processor to function as a control-program design device that designs the control program of the manufacturing apparatus;
causing the processor to function as a control-program slicing device that extracts a common group in which program blocks in the control program share a device;
causing the processor to function as a final-machine-design-product simulator that virtually operates a final design product of the machine design device;
causing the processor to function as an final-electric-design-product simulator that virtually operates a final design product of the electric design device;
causing the processor to function as a final-control-program-design-product simulator that virtually operates a final design product of the control-program design device; and
causing the processor to function as a moving-part interference determiner that operates the final-machine-design-product simulator, the final-electric-design-product simulator, and the final-control-program-design-product simulator in cooperation with one another to determine whether interference occurs between the moving part of the manufacturing apparatus and a residual part thereof during simulation performed by the final-machine-design-product simulator,
wherein the processor functioning as the moving-part interference determiner determines a correspondence among final design products of the machine design device, the electric design device, and the control-program design device in accordance with the common group of the control program extracted by the control-program slicing device and, when it is determined that interference occurs between the moving part of the manufacturing apparatus and the residual part thereof during the simulation performed by the final-machine-design-product simulator, identifies a portion of the control program that becomes a cause of the interference.

3. The manufacturing-apparatus design verification system according to claim 2, wherein
the processor functioning as the moving-part interference determiner causes the final-control-program-design-product simulator to execute a common group in part of the control program and, when it is determined that interference does not occur between the moving part of the manufacturing apparatus and the residual part thereof during the simulation performed by the final-machine-design-product simulator, generates verification data and stores the verification data in a verification database, the verification data describing portions of the final design products of the machine design device, the electric design device, and the control-program design device that correspond to the common group in the part executed.

4. The manufacturing-apparatus design verification system according to claim 3, wherein
the verification data is stored in the verification database as a positive example of a final design product of the manufacturing apparatus that satisfies a condition that interference does not occur between the moving part and the residual part, and
the processor functioning as the moving-part interference determiner learns, in accordance with the verification data, physical shapes and operations of the moving part and the residual part that do not cause interference.

5. The manufacturing-apparatus design verification system according to claim 2, wherein
the processor functioning as the moving-part interference determiner has a function of detecting interlock in which a moving part of the final design product of the machine design device and another moving part occupy the same space at the same time.

6. The manufacturing-apparatus design verification system according to claim 2, wherein
the processor functioning as the moving-part interference determiner has a function of detecting whether a moving part of the final design product of the machine design device operates at a predetermined tact time.

7. The manufacturing-apparatus design verification system according to claim 1, wherein
the control program is a ladder program.

8. The manufacturing-apparatus design verification system according to claim 1, wherein
the control program is a text program.

9. The manufacturing-apparatus design verification system according to claim 1, wherein
all or part of the manufacturing-apparatus design verification system is operated in a cloud.

10. The manufacturing-apparatus design verification system according to claim 2, wherein
the control program is a ladder program.

11. The manufacturing-apparatus design verification system according to claim 2, wherein
the control program is a text program.

12. The manufacturing-apparatus design verification system according to claim 2, wherein
all or part of the manufacturing-apparatus design verification system is operated in a cloud.
